(19) United States
(12) Patent Application Publication
(10) Pub. No.: US 2013/0215147 A1
(43) Pub. Date: Aug. 22, 2013

(54) Apparatus and Method for Enhancing Human Visual Performance in a Head Worn Video System

(71) Applicant: eSight Corp., (US)

(72) Inventors: Robert G. Hilkes, Ottawa (CA); Frank Jones, Carp (CA); Kevin Rankin, Kanata (CA)

(73) Assignee: eSight Corp., Ottawa (CA)

(21) Appl. No.: 13/769,353

(22) Filed: Feb. 17, 2013

Related U.S. Application Data
(60) Provisional application No. 61/599,996, filed on Feb. 17, 2012.

(51) Int. Cl. G09G 5/377

(52) U.S. Cl. CPC G09G 5/377
USPC 345/633

(57) ABSTRACT

Visual impairment, or vision impairment, refers to the vision loss of an individual to such a degree as to require additional support for one or more aspects of their life. Such a significant limitation of visual capability may result from disease, trauma, congenital, and/or degenerative conditions that cannot be corrected by conventional means, such as refractive correction, such as eyeglasses or contact lenses, medication, or surgery. According to embodiments of the invention a method of augmenting a user's sight is provided comprising obtaining an image of a scene using a camera carried by the individual, transmitting the obtained image to a processor, selecting an algorithm of a plurality of spectral, spatial, and temporal image modification algorithms to be applied to the image by the processor, modifying the using the algorithm substantially in real time, and displaying the modified image on a display device worn by the individual.

### FIELD OF THE INVENTION

The invention relates to head worn displays and more specifically to augmenting sight for people with vision loss.

### BACKGROUND OF THE INVENTION

Visual impairment, or vision impairment, refers to the vision loss of an individual to such a degree as to require additional support for one or more aspects of their life. Such a significant limitation of visual capability may result from disease, trauma, congenital, and/or degenerative conditions that cannot be corrected by conventional means, such as refractive correction, such as eyeglasses or contact lenses, medication, or surgery. This degree of functional vision loss is typically defined to manifest with:
a corrected visual acuity of less than 20/60;
a significant central visual field defect;
a significant peripheral field defect including bilateral visual defects or generalized contraction or constriction of field; or
reduced peak contrast sensitivity in combination with any of the above conditions.

However, in the United States and elsewhere, more general terms such as “partially sighted”, “low vision”, “legally blind” and “totally blind” are used to describe individuals with visual impairments rather than quantified visual acuity. As human brain-eye combination is fundamental to how we perceive and interact with both the real and virtual worlds any degradation may have significant impact to the individuals quality of life. Whilst there are many components of the human eye and brain that impact perception, vision, stability, and control only a few dominate the path from eye to the optic nerve and therein to the brain, namely the cornea, lens, vitreous body, and retina. For age groups 12-19, 20-39, and 40-59 within the United States approximately 93%, 90%, and 92% of visual impairments can be corrected by refractive means.

Such refractive means include eyeglasses, contact lenses, and laser surgery and are normally used to correct common deficiencies, namely myopia, hyperopia, astigmatism, and presbyopia by refractive corrections through the use of concave, convex, and cylindrical lenses. However, within the age grouping 60+ this ability to correct visual impairments drops significant to approximately 60%. In fact the ability to employ refractive corrections drops essentially continuously with increasing age as evident from Table 1 below.

TABLE 1
Dominant Vision Disorders That Cannot
be Addressed with Refractive Correction

| | 40-49 | 50-59 | 60-69 | 70-79 | 80+ |
|---|---|---|---|---|---|
| Intermediate Macular | 2.0% | 3.4% | 6.4% | 12.0% | 23.6% |
| Degeneration | | | | | |
| Advanced Macular | 0.1% | 0.4% | 0.7% | 2.4% | 11.8% |
| Degeneration | | | | | |
| Glaucoma | 0.7% | 1.0% | 1.8% | 3.9% | 7.7% |
| Low Vision | 0.2% | 0.3% | 0.9% | 3.0% | 16.7% |
| (from all causes) | | | | | |

| | 40-49 | 50-64 | 65-74 | 75+ |
|---|---|---|---|---|
| Diabetic Retinopathy | 1.4% | 3.8% | 5.8% | 5.0% |

Amongst the eye disorders that cannot be addressed through refractive correction include retinal degeneration, albinism, cataracts, glaucoma, muscular problems that result in visual disturbances, corneal disorders, diabetic retinopathy, congenital disorders, and infection. Age-related macular degeneration for example, currently affects approximately 140 million individuals globally and is projected to increase to approximately 180 million in 2020 and 208 million in 2030 (AgingEye Times “Macular Degeneration Types and Risk Factors”, May 2002 and United Nations “World Population Prospects—2010 Revision”, June 2011). Additionally visual impairments can arise from brain and nerve disorders, in which case they are usually termed cortical visual impairments (CVI).

Accordingly it would be evident that a solution to address non-refractive corrections is required. It would be further evident that the solution must address multiple disorders including, but not limited to those identified above, which manifest uniquely in each individual. For example myopia, shortsightedness, corrected refractively with lenses is achieved through providing a concave lens of increasing strength with increasing myopia and accordingly a single generic lens blank can be machined to form concave lenses for a large number of individuals suffering from myopia or if machined to form convex lenses those suffering hyperopia. In contrast, macular degeneration will be unique to each individual in terms of the regions degenerating and their location. It would therefore be beneficial to provide a solution that corrects for visual impairments that cannot be corrected refractively that is customizable to the specific requirements of the user. Further, it would beneficial for the correction to account for varying requirements of the user according to their activities and/or context of their location as provided for example by bifocals or progressive bifocal lenses with refractive corrections.

Accordingly the inventors have invented a head-worn or spectacle-mounted display system which derives its image source from a video camera mounted similarly, wherein the optical characteristics of the camera system, the display system and possibly even the video file format, are designed to match with the individual's visual impairment be it through retinal performance, nervous disorder, and/or higher order processing disorder. Typically, such a system would take advantage of the wearer's natural tendency to position their head/neck, and therefore the camera, so that an object of interest is positioned in the preferred location in the display. This is most commonly in the center of the display Field of View (FOV) but can be eccentrically located in some cases to avoid blind spots such as caused for example by Macular Degeneration or other visual diseases as described above.

There are several potential advantages to a system that closely matches the characteristics of human visual behavior and performance in this way. The design and selection of optical components could be optimized for very high performance near the center, most accurate regions of the human vision system, with significantly relaxed performance specifications at the periphery of the same. Alternatively the performance may be optimized for non-central regions of the human vision system or to exploit physiological and psychological characteristics of the individual's vision system. Furthermore, video image file formats, and the transmission of this data through the system could be similarly optimized so that other important parameters such as power consumption, video frame rate, latency, etc. can be improved.

It would be further beneficial where the head-worn or spectacle mounted video display system presents the video to the individual's eye in a manner wherein it is intentionally altered to take advantage of the natural physiological behavior of the entire human vision system from the retinal photoreceptors and nerve cells through the occipital lobe and cerebral cortex. The video presented to the individual's eye may be modified spectrally, spatially and/or temporally to improve the individual's perception and functional vision.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate drawbacks in the prior art in addressing visual impediments of individuals using head worn displays.

In accordance with an embodiment of the invention there is provided a method comprising:
(i) obtaining an image of a scene viewed by a user using a camera;
(ii) modifying a first predetermined portion of the image in substantially real time using an electronic processor in dependence upon at least one of a predetermined target wavelength range and a predetermined target intensity range, the at least one of determined in dependence upon a characteristic of the user's visual defect;
(iii) modifying the image in substantially real time using the electronic processor by alternately applying the modified first predetermined portion to the first predetermined portion of the image and a second predetermined portion of the image at a predetermined rate; and
(iv) displaying the modified image to the user using a display connected to the electronic processor.

In accordance with an embodiment of the invention there is provided a device comprising:

a camera for obtaining an image of a scene viewed by a user;
an electronic processor for receiving the image from the camera and executing an application to process the image for display to the user, the processing of the image comprising:
(i) modifying a first predetermined portion of the image in substantially real time using an electronic processor in dependence upon at least one of a predetermined target wavelength range and a predetermined target intensity range, the at least one of determined in dependence upon a characteristic of the user's visual defect;
(ii) modifying the image in substantially real time using the electronic processor by alternately applying the modified first predetermined portion to the first predetermined portion of the image and a second predetermined portion of the image at a predetermined rate; and
   a display connected to the electronic processor for displaying the modified image to the user.

A non-transitory tangible computer readable medium encoding a computer program for execution by a microprocessor, the computer program comprising the steps of:
(i) receiving image data relating to an image;
(ii) modifying a first predetermined portion of the image data in substantially real time using an electronic processor in dependence upon at least one of a predetermined target wavelength range and a predetermined target intensity range, the at least one of determined in dependence upon a characteristic of the user's visual defect;
(iii) modifying the image data in substantially real time using the electronic processor by alternately applying the modified first predetermined portion to the first predetermined portion of the image and a second predetermined portion of the image at a predetermined rate; and
(iv) providing the modified image data to a display for presentation to a user.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIGS. 1A through 1D depict background information about the human vision system, including the positional density of rods and the three different cone types in the human eye, and their respective response characteristics to different wavelengths (colors) of light;

FIG. 2 depicts the acuity of the human vision system, expressed as 20/X, a nomenclature commonly understood in the field of human visual performance, and more particularly, FIG. 2 shows how acuity changes as the object being viewed moves away from one's most accurate, central vision;

FIG. 3 is a schematic representation of the human eye;

FIG. 4 shows a visual acuity plot, similar to FIG. 2, but for a person challenged with severe peripheral vision loss, or so-called “tunnel vision”;

FIG. 5 is a depiction of how a person with severe peripheral vision loss might perceive the world;

FIG. 6 shows a visual acuity plot, similar to FIG. 2, but for a person challenged with a central blind spot, or so-called “scotoma”;

FIG. 7 is a depiction of how a person with a significant central blind spot might perceive the world as well as the concept of a “preferred retinal location” (PRL), indicating where said person might prefer to direct their gaze in order to view object details;

FIG. 8 depicts the concept that a large display viewed at a distance, or a small display with an identical number of pixels viewed at a closer distance, present an identical image to the human retina;

FIGS. 9A and 9B depicts how 2400 pixels, for example, can be used to show a large field of view image with low resolution, or conversely to show higher levels of detail in a smaller field of view;

FIG. 10A depicts an example of edge enhancement;

FIG. 10B depicts an example of edge enhancement that uses spectral (color and contrast), spatial (line thickness) and temporal (frame to frame variation) enhancements to improve human visual performance;

FIG. 11 depicts a schematic diagram of an embodiment of the system of the invention;

FIG. 12 depicts a portable electronic device supporting a head mounted device according to an embodiment of the invention; and

FIG. 13 depicts a bioptic head mounted device according to the prior art supporting embodiments of the invention.

### DETAILED DESCRIPTION

The present invention is directed to head worn displays and more specifically to augmenting sight for people with vision loss.

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment. It being understood that various changes may be made in the function and arrangement of elements without departing from the spirit and scope as set forth in the appended claims.

A “personal electronic device” (PED) as used herein and throughout this disclosure, refers to a wireless device used for communication that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, and an electronic reader. A “head mounted display” (HMD) as used herein and throughout this disclosure refers to a wearable device that incorporates an image capturing device and an image presentation device operating in conjunction with a microprocessor such that a predetermined portion of an image captured by the image capturing device is presented to the user on the image presentation device. Alternatively in some cases, the source of the image for display to the wearer of the HMD may come from a remotely attached camera or any video source. The microprocessor and any associated electronics including, but not limited to, memory, user input device, gaze tracking, context determination, graphics processor, and multimedia content generator may be integrated for example with the HMD, form part of an overall assembly with the HMD, form part of the PED, or as discrete unit wirelessly connected to the HMD and/or PED.

A “user” or “patient” as used herein and through this disclosure refers to, but is not limited to, a person or individual who utilizes the HMD either as a patient requiring visual augmentation to fully or partially overcome a vision defect or as an ophthalmologist, optometrist, optician, or other vision care professional preparing a HMD for use by a patient. A “vision” defect as used herein may refer to, but is not limited, a physical defect within one or more elements of a user's eye, a defect within the optic nerve of a user's eye, a defect within the nervous system of the user, a higher order brain processing function of the user's eye, and an ocular reflex of the user.

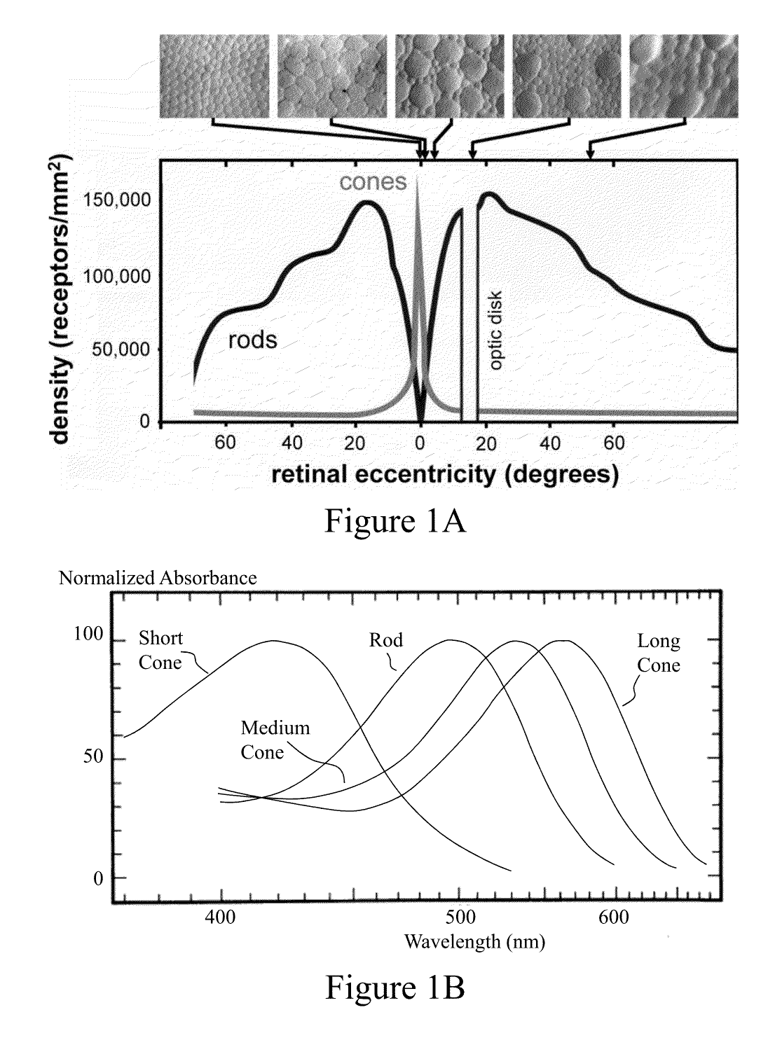

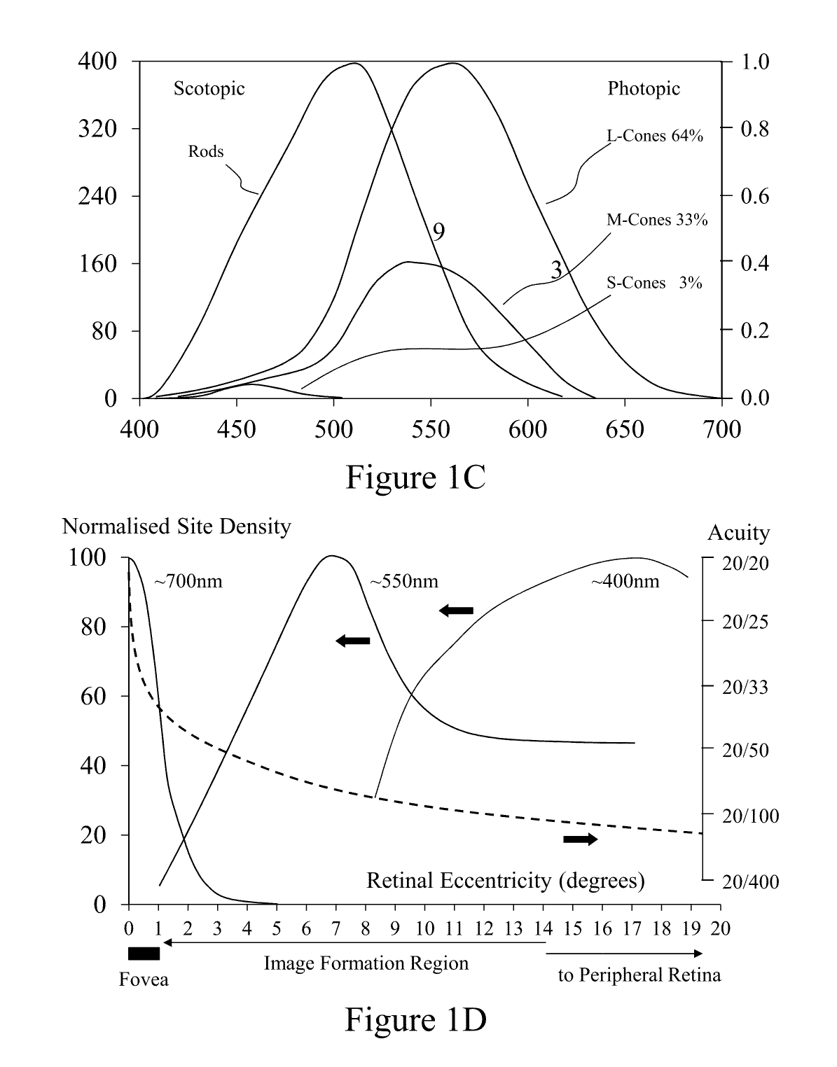

The human visual system is characterized by very high visual acuity in the center of the visual field, and very poor acuity in the periphery. This is determined by the density of light sensitive photoreceptors on the human retina, the so called “rods” and “cones”. There are about six million cones in the human visual system (per eye), which are heavily concentrated in the central few degrees of a person's normal 180-190 degree field of view as shown in FIG. 1A, and contribute to a person's accurate vision and color perception. There are three types of cones differentiated by length, namely short, medium and long cones. Medium and long cones are primarily concentrated to the central few degrees whilst short cones are distributed over a large retinal eccentricity. In contrast there are about 120 million rods distributed throughout the retina which contribute to peripheral performance and are particularly sensitive to light levels, sudden changes in light levels, and are very fast receptors.

Referring to FIG. 1B the normalized absorbance of rods and cones as a function of wavelength. As shown rod absorbance peaks at around 498 nm whereas short, medium, and long cones peak at around 420 nm, 534 nm, and 564 nm respectively. Accordingly, short, medium, and long cones provide blue, green and red weighted responses to the field of view of the individual. As depicted in FIG. 1C the average relative sensitivity of the rods on the left axis and three different cone types on the right hand axis cones. Peak rod sensitivity is 400 for the rods compared with 1 for the cones such that rods provide essentially monochromatic vision under very low light levels. It is also evident that the sensitivity of short, medium, and long cones also varies wherein short cones are approximately 20 times less sensitive than long cones. In a similar manner, long cones represent 64% of the cones within the human eye, medium cones 33% and short cones only 3%. The combinations of relative sensitivity, spectral sensitivities of the different cone types, and spatial distributions of the different cones types result in effective wavelength/spatial filtering of the human eye as a function of retinal eccentricity as depicted in FIG. 1D. Accordingly as visual acuity drops from 20/20 at the fovea, approximately the first degree of retinal eccentricity to below 20/100 above 15 degrees the effective wavelength response of the human eye is red dominant at the fovea transitioning to a green dominant region between a few degrees to approximately 10 degrees followed by a blue dominant region thereafter although the rod spectral response still provides significant green sensitivity.

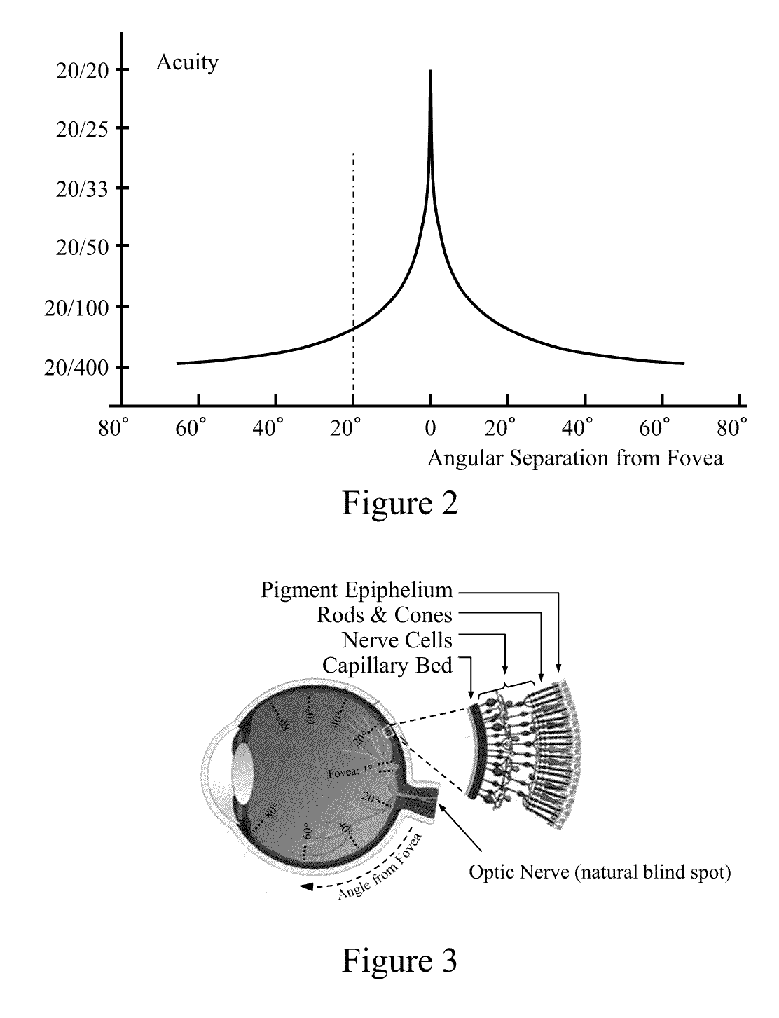

The corresponding visual acuity of a person with healthy eyesight is shown in FIG. 2. The common nomenclature “20/X” indicates that a person can see at 20 meters, what a healthy-sighted person could see from X meters. As shown, human vision is highly accurate in the very central 1-2 degrees of a person's visual field. 20/20 vision corresponds to a person being able to perceive an object that subtends about one minute of arc, about 1/60^{th} degree, on the retina in the center of their vision. At the outer periphery of a person's vision, their acuity drops significantly such that as shown in FIG. 2 outside of ±30 degrees drops to below 20/200.

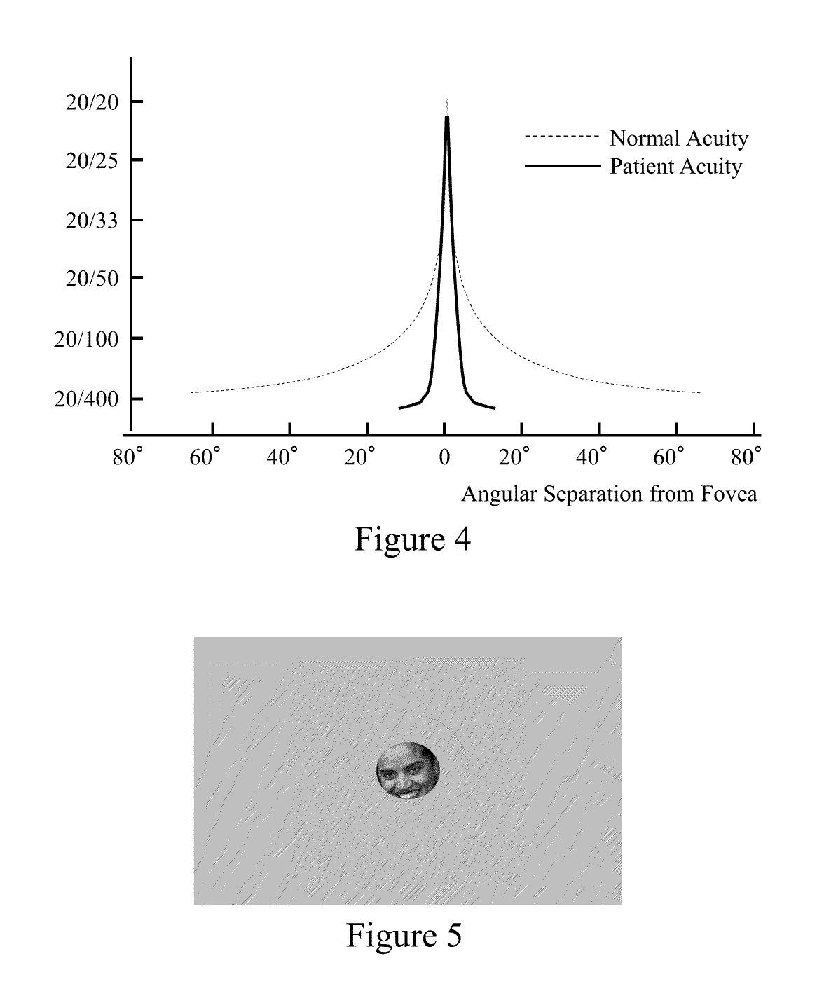

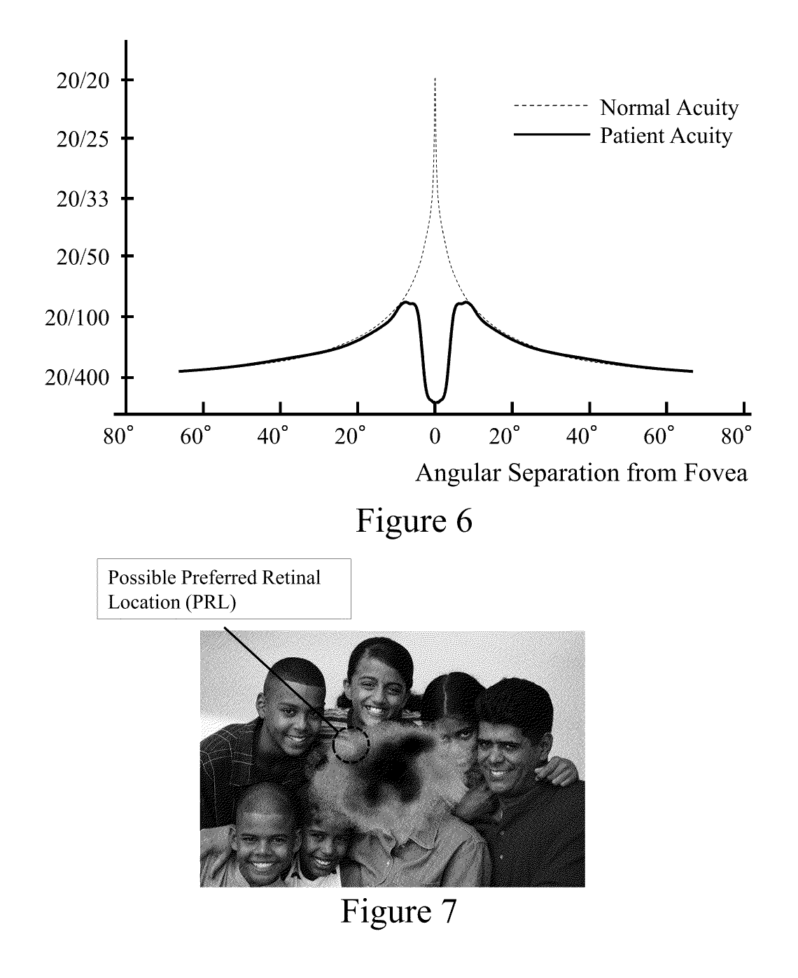

Some vision diseases such as Retinitis Pigmentosa, Glaucoma, and Ushers, cause damage to a person's peripheral field of view, resulting in so-called “tunnel vision”. The resulting acuity plot may look like that depicted in FIG. 4. An example of how an individual might perceive tunnel vision is depicted in FIG. 5. Other diseases such as Macular Degeneration, attack the central vision, resulting in an acuity plot similar to that depicted in FIG. 6. An example of how an individual might perceive a central blind spot or scotoma is depicted in FIG. 7.

Referring to FIG. 3 there is depicted a schematic view of the human eye, with particular detail placed upon the various types of cells that comprise the retina. Photons enter the eye via the pupil and are focused on the retina via the lens and cornea at the front of the eye. Cells in the retina are stimulated by incident photons in three ways. First, retinal photoreceptors, the rods and cones, respond to spectral qualities of the light such as wavelength and intensity. These in turn stimulate the retinal nerve cells, comprising bipolar cells, horizontal cell, ganglion cells, and amarcine cells. Although physically located in the eye, these nerve cells can be considered the most primitive part of the human brain and cortical visual function. It has also been shown that the response of photoreceptors and nerve cells improves when neighboring cells receive different spectral information. This can be considered the retina's response to spatial stimulus, that being the differences spatially between the light information incident on adjacent areas of the retina at any moment in time.

Accordingly, contrast can be defined as spectral transitions, changes in light intensity or wavelength, across a small spatial region of the retina. The sharper these transitions occur spatially, the more effectively the human vision system responds. Additionally, the eye responds to temporal changes in information, i.e. where the information stimulating photoreceptors and retinal nerve cells changes either because of object motion, head/eye motion, or other changes in the spectral/spatial information from one moment in time to the next. It is important to note that a significant portion of the human visual function takes place in the brain. In fact, retinal nerve cells can be considered an extension of the cerebral cortex and occipital lobe of the brain.

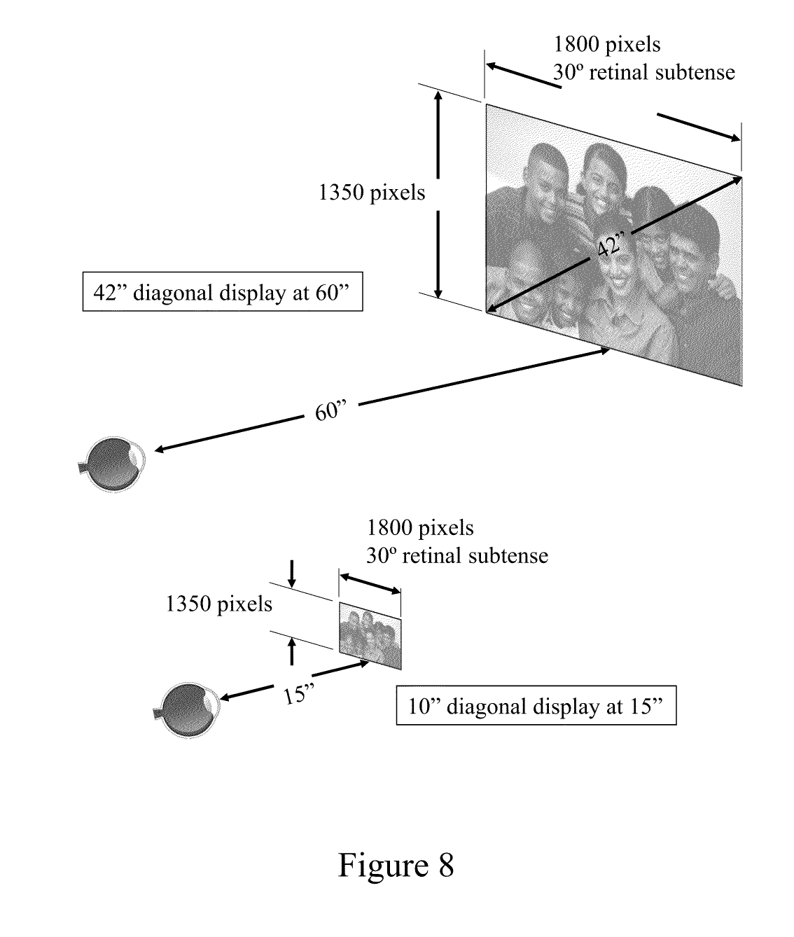

To maximize display resolution in any display system the minimum angle of resolution (“MAR”) a single pixel, that being the smallest physical representation of light intensity and colour in an electronic display, subtends on the human retina ought to be about 1 minute of arc angle, corresponding to 20/20 human performance. Furthermore, because the eye can fixate on any portion of the display system, this resolution for most video systems such as televisions, portable gaming consoles, computer displays etc needs to be constant across the display. Indeed, all common image file formats and electronic image sensor and display technologies used in video systems today assume a consistent pixel size throughout the entire image area. As an example, to achieve 20/20 perceived acuity on a 4×5 aspect ratio electronic display with a 42″ diagonal size, at a distance of 60″ from the viewer requires 1800×1350 pixels, or approximately 2.4 million equally sized pixels. This display would subtend approximately 30 degrees (horizontally) of an individual's visual field at the 60″ distance. The same pixel count would be required in a 10″ display viewed at one quarter of the distance, i.e. one subtending same angular range, or a larger display viewed from further away, again, same subtended angle on the human retina. This is depicted in FIG. 8.

A head-mounted display (HMD) or otherwise called head-worn, or head-borne display, uses a near-to-eye, head-mounted, or spectacle-mounted display, in which the screen is typically less than an inch in size, and special optics are designed to project it onto the wearer's retina, giving the perception of viewing a larger display at a distance. According to embodiments of the invention this display and optics assembly projects the image to the user through the individual's eyeglasses or contact lenses which provide refractive correction wherein the display is used in conjunction with the individual's eyesight. In other embodiments the display provides the sole optical input to the individual's eye. In other embodiments a single display is used with either the left or right eye whereas in others two displays are used, one for each eye.

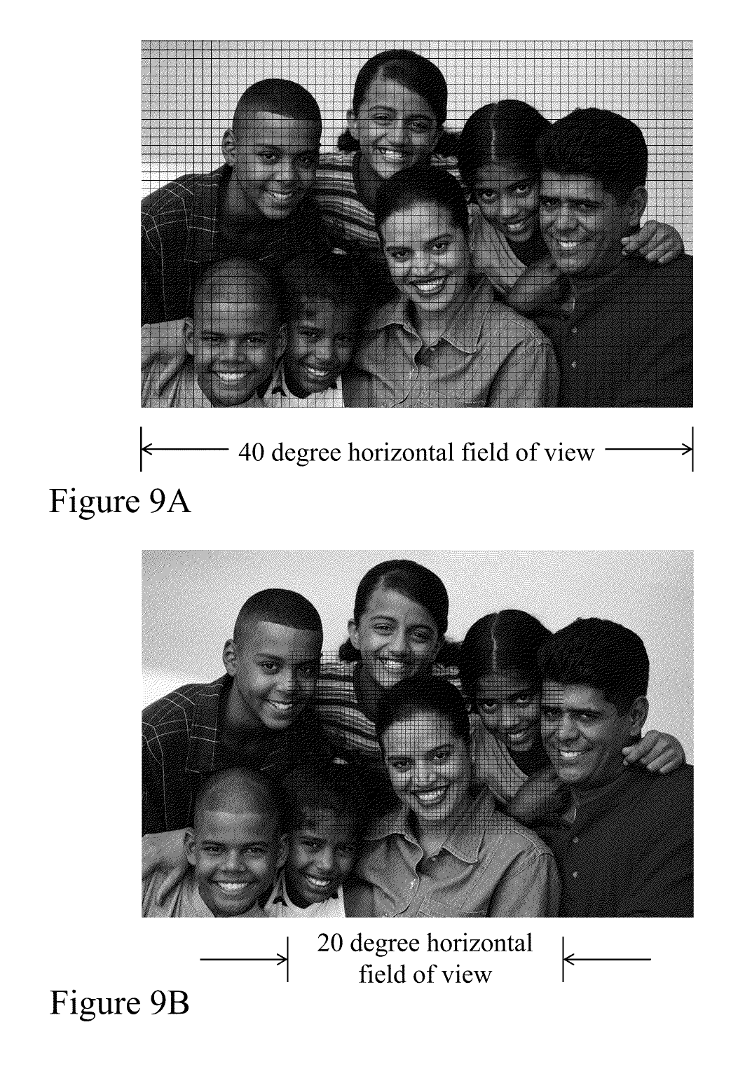

One of the significant challenges in developing head borne displays has been the tradeoff between display acuity, normally expressed in terms of pixel resolution or pixel size, that being the number of arc minutes subtended by a single pixel on the viewer's retina, as described above in respect of FIG. 8, and the field of view (FOV) of the entire image, normally expressed in degrees. These two important parameters trade off; because of the physical limits of optical design, and the current limitations of electronic micro-displays. A larger FOV with the same number of display pixels results in a lower resolution image, i.e. the pixels subtend a larger area on the viewer's retina. Conversely, increasing the resolution by creating smaller pixels, without increasing the pixel count will result in a smaller, lower FOV, image. These tradeoffs are demonstrated in FIGS. 9A and 9B respectively wherein an exemplary 60×40 pixel array, i.e. a 2400 pixel image, is presented. It would be evident to one skilled in the art that typically higher pixel count displays, increased resolution, would be employed.

In an HMD that derives its image from a head- or spectacle-mounted video camera, the wearer's natural behavior will be to position the head and therefore the camera, such that the object of interest is positioned in the center of the display FOV. This provides a relaxing viewing posture for most individuals, adjusting the neck/head and ultimately body posture so that the eyes can relax in a centrally fixated position on the display. When the viewer perceives an object of interest in the display periphery, which is also the camera periphery, they will naturally move their head/neck/body posture so that the object is centered in the camera and therefore the display, allowing their gaze fixation to return to the most comfortably viewed area, typically the FOV center.

For wearers whose central visual field is damaged by a blind spot or visual scotoma typical of diseases such as Macular Degeneration, they may choose to position the head/neck and therefore the camera, such that the image is displayed at a preferred location that is different from the FOV center. This eccentric area of maximum visual acuity is often called a “preferred retinal loci” (“PRL”) by ophthalmologists and other vision care professionals. This preferred retinal location is depicted by the circle in FIG. 6.

The acuity of human vision is maximized when the information presented to the retina provides high contrast between adjacent photoreceptors. The limit case of this is known as the retinal “yes-no-yes” response, wherein two retinal cells are stimulated and a third, situated between the first two, is not. This can be imagined as two of the horizontal bars in the “E” on an optometrist's eye chart, separated by white space of identical width, corresponding to three retinal photoreceptors. The human eye cannot discern detail that subtends smaller angles than these on the human retina. The lines and corresponding spaces for any letter on the 20/20 row of an optometrist's acuity test chart will each occupy one minute of arc, one 60^{th} of one degree, on a person's retina when viewed at a distance of twenty feet.

To optimize human visual performance in a head-worn or spectacle-mounted video display system, the image ought to be sufficiently “bright” to ensure as many photons as possible are carrying information to the retina. This is known as image luminance to one skilled in the art. Furthermore, improving the contrast in the image, defined as the luminance transition spatially in the image, can further improve visual performance. High contrast signals are characterized by large luminance differences, that being the difference between the brightest and darkest information in an image, across a small spatial distance. These high contrast signals are more easily processed by the human visual system, and carry the greatest information content to the human brain.

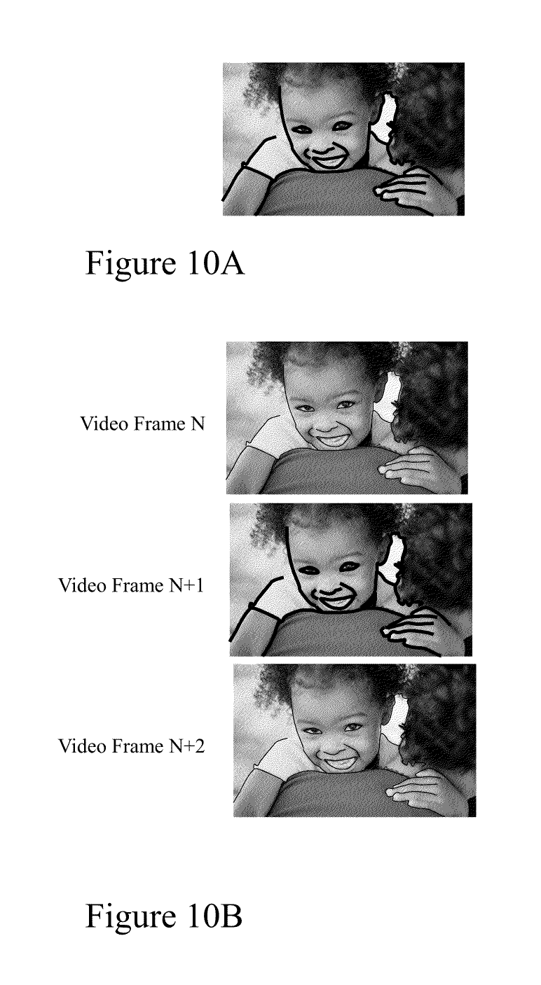

When presenting a video image to the human vision system, visual performance can be improved further by intentionally altering the video image in the spectral, spatial or temporal domains. There are a number of ways to do this. Algorithms can enhance regions where luminance changes rapidly, such as at the edges of objects in the video image for example. The degree to which an object edge is enhanced can be varied spectrally, spatially and temporally. An example of a spectral variation in an object edge could be the color of the line used to define the edge as shown in FIG. 10A. In this case, edges of the object are shown by a high contrast dark line but they might alternatively be depicted with a red line for example. FIG. 10B shows an example of spectral, spatial and temporal edge enhancement. The edge is enhanced spectrally by alternating between black and blue for alternate frames such that frames N and N+2 are black for example and frame N+1 is blue.

It would be evident that different colours, different frame counts, and different sequences may be employed which may vary according to the individual for example or contextual factors such ambient environment, image complexity, image type etc. It may be further enhanced spatially by changing the thickness of the line. Such a spectral/spatial/temporal enhancement can significantly improve human visual performance, especially in a person challenged by visual impairment through disease or other causes.

Another way to enhance human visual performance in a head-worn or spectacle-mounted video system is to enhance the characteristics of objects in motion relative to other objects. For example, an image processing algorithm could identify an object such as a car that is in motion relative to the background information in the scene, and enhance it by increasing its contrast, altering its color, or enhancing its outline using the methods described above. In this manner, the car will become more visible in the video scene. For a person wearing an HMD and viewing the world through the video image, this can significantly improve their functional performance and safety.

According to another embodiment of the invention the HMD may be displaying to the user a partial FOV centered upon a Region of Interest (ROI) specified by the user either through an input to the HMD via an interface, gaze tracking, etc. In this instance the user will be unaware of visual content affecting them outside this partial FOV. Accordingly the HMD and/or an associated processing may be processing the full FOV to determine whether additional data should be presented to the user. For example the user is walking along a busy sidewalk and the HMD is presenting modified visual data to allow the user to walk along the path when the HMD determines a fast moving image element and identifies this to the user by an element such as a warning icon or an audible signal for example or by adjusting the display image to include that portion of the FOV.

According to another embodiment of the invention the HMD may determine a moving ROI for the user based upon head/neck movement, through gaze tracking, or HMD/PED gyroscopic sensors for example. At the same time the HMD may determine from the sequence of images an object or objects within the image that either has motion correlating to that of the user or has limited motion compared to an overall opposite motion for the bulk of the image. Accordingly, the HMD may determine that the object is actually the ROI and perform one or more image enhancements to that object or objects. Optionally, the user may notify the HMD that the identified object is to be stored within memory for subsequent recall. At a later date the user within a similar or different context may select the stored identified object as an element they wish highlighted within the displayed ROI/FOV whenever it is identified by the HMD. For example, a user may watch a hockey game and determine that they wish to have the puck highlighted or enhanced specifically to increase their visual engagement with the game. Accordingly, once stored the user may recall the object such that the HMD automatically identifies the object irrespective of whether its motion is correlated to an aspect of the display image. In another scenario a user walking near traffic may have the traffic enhanced such that the HMD may reduce the risk for a visually impaired user in such environments.

In another embodiment of the invention the HMD may present part of the FOV to the user but determine that an information sign is within that portion of the FOV not being displayed to the user. Accordingly, the HMD projects that portion of the FOV containing the information sign into the partial FOV being presented to the user. Determination of information signs may be made based upon establishing a series of objects, such as described above, and/or rules. These objects and/or rules may be contextually determined.

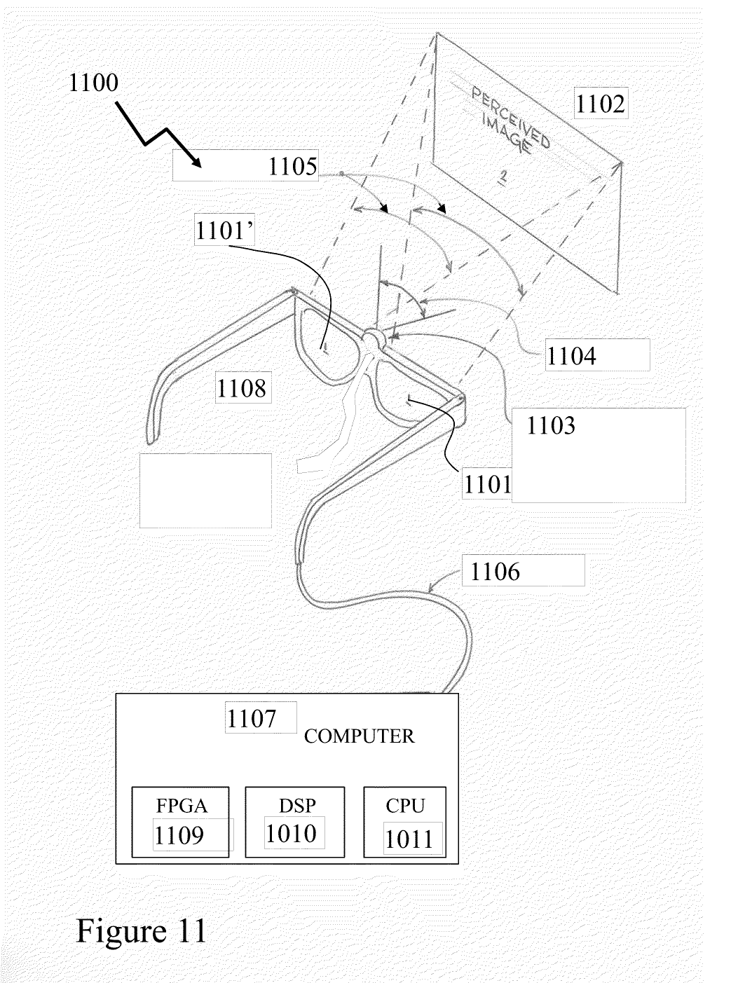

Referring to FIG. 11 there is depicted according to an embodiment of the invention a system 1100 which includes a pair of eyeglass frames 1108, alternatively a head mounted display, and a computer 1107. According to this embodiment of the invention, the traditional transparent lenses in the eyeglass frame 1108, have been replaced with one or two display screens 1101, 1101′ (generally 1101), such as an LED display for example. Attached to the eyeglass frame 1108 are one or more image capture devices 1103, such as a CCD camera for example. The electronics associated with image capture device 1103 provide for image capture of a scene of interest 1102, that subtends a certain field of view 1104. The image is captured by the image capture device 1103, and transmitted to the computer 1107 by way of a wired link 1106. The computer 1107 modifies the video image using real-time processing in a combination of a field programmable gate array (FPGA) 1109, a digital signal processor 1110, and a central processing unit 1111 such as a microprocessor, collectively, the computer 1107. The computer 1107, then returns the modified video image back to the eyeglass frames 1108 for display on one or both of the display screens 1101, 1101′. The resulting image is perceived as a large video scene 1105.

Certain aspects of the computer 1107, can be replaced by an application specific integrated circuit (ASIC). It would be evident to one skilled in the art that computer 1107 may be a portable electronic device including for example a smartphone, cellular telephone, or portable multimedia player. Wired link 1106 may for example be a HDMI interface although other options including, but not limited to, USB, RS232, RS485, USB, SPC, I2C, UNI/O, Infiniband, and 1-wire. Alternatively wired link 1106 may be replaced with a wireless link operating for example according to a wireless personal area network (WPAN) or body area network (BAN) standard such as provided by IEEE 802.15 or Bluetooth for example.

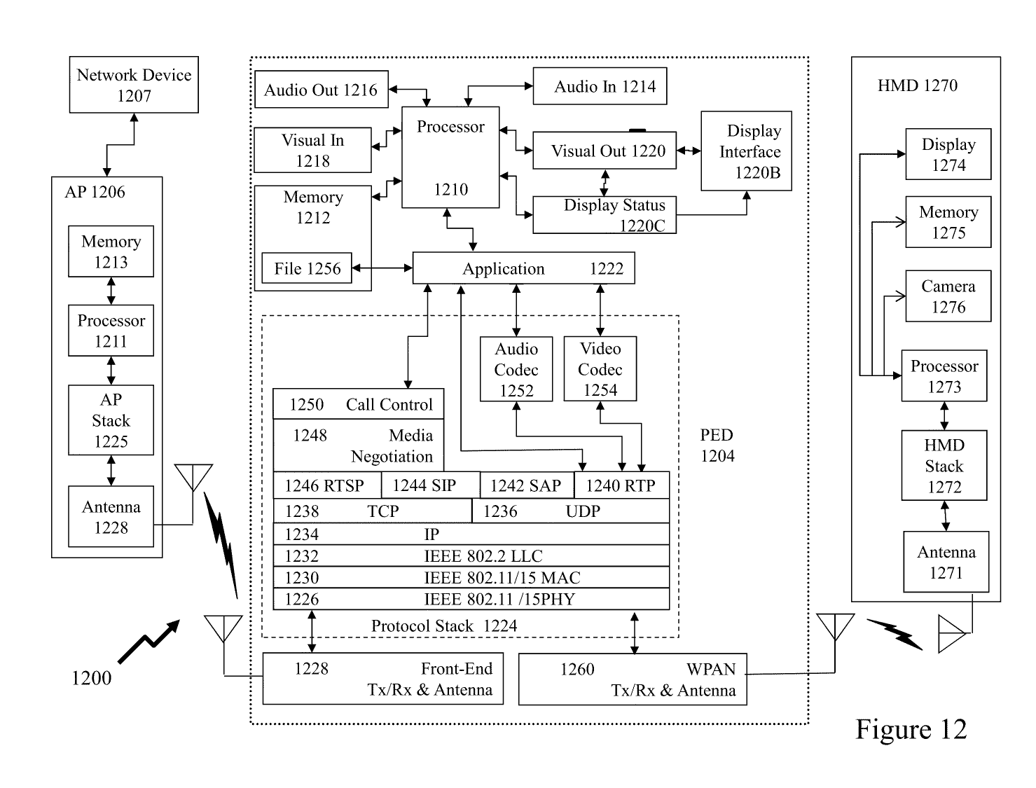

Referring to FIG. 12 there is depicted a portable electronic device 1204 supporting an expandable screen according to an embodiment of the invention. Also depicted within the PED 1204 is the protocol architecture as part of a simplified functional diagram of a system 1200 that includes a portable electronic device (PED) 1204, such as a smartphone, an access point (AP) 1206, such as first Wi-Fi AP 110, and one or more network devices 1207, such as communication servers, streaming media servers, and routers for example such as first and second servers 175 and 185 respectively. Network devices 1207 may be coupled to AP 1206 via any combination of networks, wired, wireless and/or optical communication. The PED 1204 includes one or more processors 1210 and a memory 1212 coupled to processor(s) 1210. AP 1206 also includes one or more processors 1211 and a memory 1213 coupled to processor(s) 1211. A non-exhaustive list of examples for any of processors 1210 and 1211 includes a central processing unit (CPU), a digital signal processor (DSP), a reduced instruction set computer (RISC), a complex instruction set computer (CISC) and the like. Furthermore, any of processors 1210 and 1211 may be part of application specific integrated circuits (ASICs) or may be a part of application specific standard products (ASSPs). A non-exhaustive list of examples for memories 1212 and 1213 includes any combination of the following semiconductor devices such as registers, latches, ROM, EEPROM, flash memory devices, non-volatile random access memory devices (NVRAM), SDRAM, DRAM, double data rate (DDR) memory devices, SRAM, universal serial bus (USB) removable memory, and the like.

PED 1204 may include an audio input element 1214, for example a microphone, and an audio output element 1216, for example, a speaker, coupled to any of processors 1210. PED 1204 may include a video input element 1218, for example, a video camera, and a visual output element 1220, for example an LCD display, coupled to any of processors 1210. The visual output element 1220 is also coupled to display interface 1220B and display status 1220C. PED 1204 includes one or more applications 1222 that are typically stored in memory 1212 and are executable by any combination of processors 1210. PED 1204 includes a protocol stack 1224 and AP 1206 includes a communication stack 1225. Within system 1200 protocol stack 1224 is shown as IEEE 802.11/15 protocol stack but alternatively may exploit other protocol stacks such as an Internet Engineering Task Force (IETF) multimedia protocol stack for example. Likewise AP stack 1225 exploits a protocol stack but is not expanded for clarity. Elements of protocol stack 1224 and AP stack 1225 may be implemented in any combination of software, firmware and/or hardware. Protocol stack 1224 includes an IEEE 802.11/15-compatible PHY module 1226 that is coupled to one or more Front-End Tx/Rx & Antenna 1228, an IEEE 802.11/15-compatible MAC module 1230 coupled to an IEEE 802.2-compatible LLC module 1232. Protocol stack 1224 includes a network layer IP module 1234, a transport layer User Datagram Protocol (UDP) module 1236 and a transport layer Transmission Control Protocol (TCP) module 1238. Also shown is WPAN Tx/Rx & Antenna 1260, for example supporting IEEE 802.15.

Protocol stack 1224 also includes a session layer Real Time Transport Protocol (RTP) module 1240, a Session Announcement Protocol (SAP) module 1242, a Session Initiation Protocol (SIP) module 1244 and a Real Time Streaming Protocol (RTSP) module 1246. Protocol stack 1224 includes a presentation layer media negotiation module 1248, a call control module 1250, one or more audio codecs 1252 and one or more video codecs 1254. Applications 1222 may be able to create maintain and/or terminate communication sessions with any of devices 1207 by way of AP 1206. Typically, applications 1222 may activate any of the SAP, SIP, RTSP, media negotiation and call control modules for that purpose. Typically, information may propagate from the SAP, SIP, RTSP, media negotiation and call control modules to PHY module 1226 through TCP module 1238, IP module 1234, LLC module 1232 and MAC module 1230.

It would be apparent to one skilled in the art that elements of the PED 1204 may also be implemented within the AP 1206 including but not limited to one or more elements of the protocol stack 1224, including for example an IEEE 802.11-compatible PHY module, an IEEE 802.11-compatible MAC module, and an IEEE 802.2-compatible LLC module 1232. The AP 1206 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module.

Also depicted is HMD 1270 which is coupled to the PED 1204 through WPAN interface between Antenna 1271 and WPAN Tx/Rx & Antenna 1260. Antenna 1271 is connected to HMD Stack 1272 and therein to processor 1273. Processor 1273 is coupled to camera 1276, memory 1275, and display 1274. HMD 1270 being for example system 1100 described above in respect of FIG. 11. Accordingly, HMD 1270 may, for example, utilize the processor 1210 within PED 1204 for processing functionality such that a lower power processor 1273 is deployed within HMD 1270 controlling acquisition of image data from camera 1276 and presentation of modified image data to user via display 1274 with instruction sets and some algorithms for example stored within the memory 1275. It would be evident that data relating to the particular individual's visual defects may be stored within memory 1212 of PED 1204 and/or memory 1275 of HMD 1270. This information may be remotely transferred to the PED 1204 and/or HMD 1270 from a remote system such as an optometry system characterising the individual's visual defects via Network Device 1207 and AP 1206.

Accordingly it would be evident to one skilled the art that the HMD with associated PED may accordingly download original software and/or revisions for a variety of functions including diagnostics, display image generation, and image processing algorithms as well as revised ophthalmic data relating to the individual's eye or eyes. Accordingly, it is possible to conceive of a single generic HMD being manufactured that is then configured to the individual through software and patient ophthalmic data. Optionally, the elements of the PED required for network interfacing via a wireless network (where implemented), HMD interfacing through a WPAN protocol, processor, etc may be implemented in a discrete standalone PED as opposed to exploiting a consumer PED. A PED such as described in respect of FIG. 12 allows the user to adapt the algorithms employed through selection from internal memory as well as define an ROI through a touchscreen, touchpad, or keypad interface for example.

Further the user interface on the PED may be context aware such that the user is provided with different interfaces, software options, and configurations for example based upon factors including but not limited to cellular tower accessed, WiFi/WiMAX transceiver connection, GPS location, and local associated devices. Accordingly the HMD may be reconfigured upon the determined context of the user based upon the PED determined context. Optionally, the HMD may determine the context itself based upon any of the preceding techniques where such features are part of the HMD configuration as well as based upon processing the received image from the camera. For example, the HMD configuration for the user wherein the context is sitting watching television based upon processing the image from the camera may be different to that determined when the user is reading, walking, driving etc. In some instances the determined context may be overridden by the user such as for example the HMD associates with the Bluetooth interface of the user's vehicle but in this instance the user is a passenger rather than the driver.

It would be evident to one skilled in the art that in some circumstances the user may elect to load a different image processing algorithm and/or HMD application as opposed to those provided with the HMD. For example, a third party vendor may offer an algorithm not offered by the HMD vendor or the HMD vendor may approve third party vendors to develop algorithms addressing particular requirements. For example, a third party vendor may develop an information sign set for the Japan, China etc whereas another third party vendor may provide this for Europe.

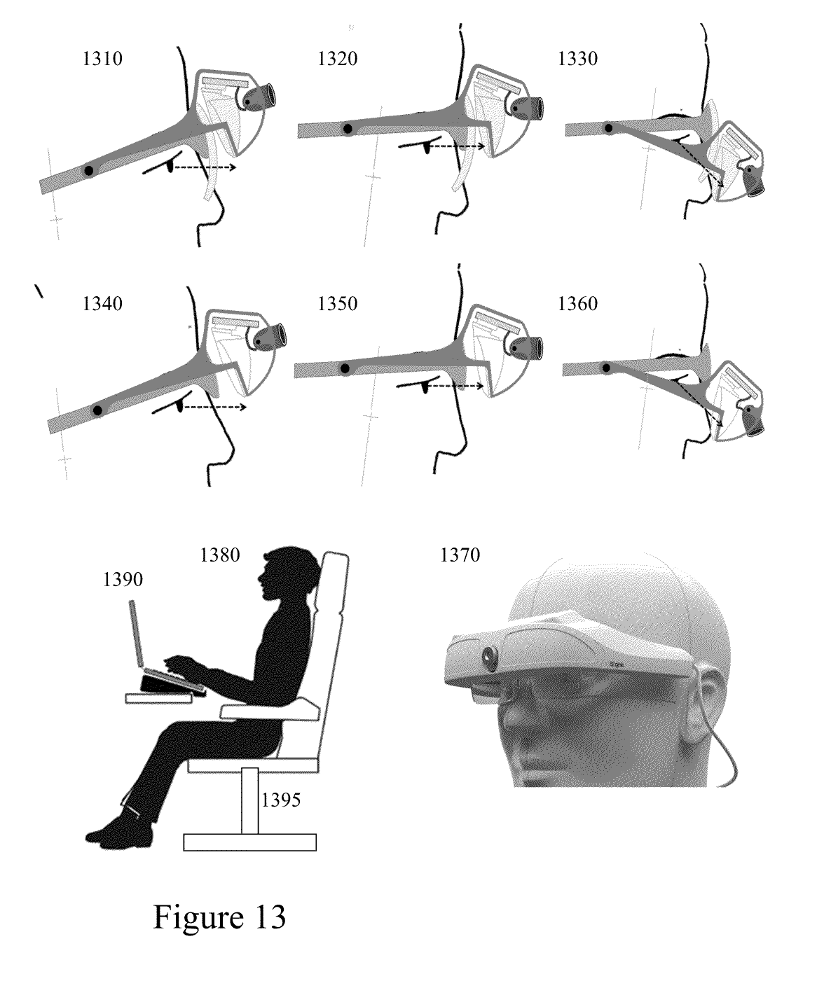

Optionally the HMD can also present visual content to the user which has been sourced from an electronic device, such as a television, computer display, multimedia player, gaming console, personal video recorder (PVR), or cable network set-top box for example. This electronic content may be transmitted wirelessly for example to the HMD directly or via a PED to which the HMD is interfaced. Alternatively the electronic content may be sourced through a wired interface such as USB, I2C, RS485, etc as discussed above. Referring to FIG. 13 there is depicted a HMD 1370 as disclosed by R. Hilkes et al in U.S. patent application Ser. No. 13/309,717 filed Dec. 2, 2011 entitled “Apparatus and Method for a Bioptic Real Time Video System” the entire disclosure of this application is incorporated by reference herein. HMD 1370 allowing a user with refractive correction lenses to view with or without the HMD 1370 based upon head tilt forwards as they engage in different activities. Within the embodiments of the invention described above and below the camera has been described as being integral to the HMD. Optionally the camera may be separate to the HMD.

In the instances that the sourced from an electronic device, such as a television, computer display, multimedia player, gaming console, personal video recorder (PVR), or cable network set-top box for example then the configuration of the HMD may be common to multiple electronic devices and their “normal” world engagement or the configuration of the HMD for their “normal” world engagement and the electronic devices may be different. These differences may for example be different processing variable values for a common algorithm or it may be different algorithms.

It would be evident to one skilled in the art that the teaching of Hilkes also supports use of a HMD 1370 by a user without refractive correction lenses. There being shown by first to third schematics 1310 to 1330 respectively in the instance of corrective lenses and fourth to sixth schematics 1340 to 1360 respectively without lenses. Accordingly a user 1380 working with a laptop computer 1390 would typically be sitting with their head in second, third, fifth, or sixth schematic orientations wherein the HMD is engaged. In this instance the laptop computer 1390 may establish a direct WPAN or wired link to the HMD 1370 thereby displaying the images to the user which would otherwise be displayed on the screen of the laptop computer. In some instances the laptop computer, due to typically increased processing resources compared to HMD 1370 or a PED to which the HMD 1370 is connected, may have software in execution thereon to take over processing from the HMD 1370 or PED.

There are many image modifications that can be performed on the display image to improve the visual function of the person wearing the HMD. These include, but are not limited to:

1. Enhance spectrally—Modifying the image so that it is optimized for the spectral response of the individual's functional visual performance. For example, if an individual is insensitive to colors in the red region of the visible light spectrum, these pixels can be remapped to other colors for which the individual's functional visual performance is better.

2. Enhance spatially—Leveraging the inherent ability of the human vision system to perceived sharp differences in luminance (spectral quality) over short distances. By increasing the slope of these luminance transitions, in other words making the transition occur over a distance of fewer pixels, the system can generate retinal synapses which might not otherwise have fired.

3. Enhance partially spatially—Spatially enhancing with an algorithm that enhances the edges of objects. In one instantiation edges can be shown to appear as high contrast lines, thereby improving human visual performance.

4. Enhance temporally—Altering specific pixels or regions of pixels sequentially in time at a predetermined rate, can help the human vision system discern more detail and motion from a video image. For example, a drawn edge could be altered in color, thickness, or location (dithering) in subsequent frames of video.

5. Enhancing objects in motion—By tracking portions of the image that are rapidly changing (e.g.: object in motion) relative to the rest of the image (e.g.: background), and applying any combination of the above enhancements, human visual performance can be improved by highlighting moving objects, which are normally of significantly greater interest to the individual than stationary information.

6. Enhancing object differentially—Adjusting the characteristics of an object identified within the image overall as opposed to just the edge. For example, the contrast on an individual's face within the image may be adjusted or magnified relative to the rest of the image. Such enhancements may be established contextually with respect to their occurrence within the image and/or the user's contextual situation. According to other embodiments of the invention image elements may differentially be reduced in emphasis or contrast relative to the remainder of the image, a process the inventor's term “dehancing.”

In some instances the visual disorder of the patient relates to the vestibulo-ocular reflex (VOR) which is a reflex eye movement that stabilizes images on the retina during head movement by producing an eye movement in the direction opposite to head movement, thus preserving the image on the center of the visual field. Since slight head movement is present all the time, the VOR is important for stabilizing vision. Patients whose VOR is impaired find it difficult to read using print, because they cannot stabilize the eyes during small head tremors. The VOR does not depend on visual input and works even in total darkness or when the eyes are closed although in the presence of light, the fixation reflex is also added to the movement. Accordingly embodiments of the invention provides for correction of VOR impairments for patients by allowing the image displayed to the user to be adjusted for consistent visual input based upon gaze tracking.

In some patients there are no impairments to the eye physically but there are defects in the optical nerve or the visual cortex. It would be evident that where such damage results in incomplete image transfer to the brain, despite there being no retinal damage for example, that manipulation of the retinal image to compensate or address such damaged portions of the optical nerve and/or visual cortex is possible using a HMD according to embodiments of the invention.

Likewise damage to the occipitotemporal areas of the brain can lead to patients having issues affecting the processing of shape and colour which makes perceiving and identifying objects difficult. Similarly, damage to the dorsal pathway leading to the parietal lobe may increase patient difficulties in position and spatial relationships. The most frequent causes of such brain injuries have been found to be strokes, trauma, and tumors. Accordingly, in addition to the techniques discussed above in respect of processing edges of objects, employing spatial—spectral—temporal shifts of image data on the retina the HMD may be utilised to adjust in real-time the image displayed to the user to provide partial or complete compensation. Neuro-ophthalmological uses of a HMD according to embodiments of the invention may therefore provide compensation of optical neuropathies including for example Graves' ophthalmopathy, optic neuritis, esotropia, benign and malignant orbital tumors and nerve palsy, brain tumors, neuro-degenerative processes, strokes, demyelinating disease and muscle weakness conditions such as myasthenia gravis which affects the nerve-muscle junction.

It would be evident to one skilled in the art that such compensations may include colour shifts and/or spatially adapted images which in many instances are addressed through a series of predetermined image transformations. This arises as unlike other visual defects such as macular degeneration for example, an ophthalmological examination cannot be performed to visually identify and quantify damage. Rather based upon the patient's particular visual perception disorder other effects may be utilized. In some instances these may exploit the high visual dynamic range of regions of the retina with rods as depicted in FIG. 1C, the spectral spatial variations across the retina as described above in respect of FIG. 1D, or the spectral sensitivity differences between different cones within the same region of the retina for example. In others elements of the image may be selectively modified to address particular processing defects such that for example an inability to determine a particular shape results in the HMD adjusting those shapes within any image that contains them.

Within embodiments of the invention described above images presented to the user have been described as having temporal variations which are implemented at a predetermined rate such as for example as described in respect of FIG. 10B for example. Alternatively this rate may be varied according to one or more factors including, but not limited to, user preference, aspect of image being varied, and context. In other embodiments of the invention this rate may be varied to overcome any potential “learning to ignore” aspect of the user's visual process. Introducing variance in the effect frequency may cause the user's brain or photoreceptors to respond more effectively in the short and/or long term. With some visual disorders there may be benefit to dynamically selecting or adjusting the frequency. However, at present the absence of HMD devices allowing such effects to be applied and varied means that such effects have not been investigated.

According to embodiments of the invention the HMD may use hardware components including image sensors, lenses, prisms and other optical components, and video displays, that mimic the inherent performance of human vision in terms of visual and cognitive spatial acuity, visual and cognitive spectral response or sensitivity to color and contrast, and visual and cognitive temporal response or sensitivity to difference in visual information from one moment in time to the next. Examples of this biomimicry could include components that have higher resolution and better color representation in the center of the field of view, and relaxed resolution and color representation, but faster refresh performance at the extremities of the field of view, thereby mimicking the natural performance characteristics of human vision.

A further embodiment of the invention could also include image file formats that are well-suited for the aforementioned biomimicking physical components. For example, a file format that does not presuppose a constant pixel size or color depth can be envisioned, wherein the resolution is much higher and color depth much greater in the center of the image than at the extremities, but the frame rate is faster at the extremities.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method comprising:
(i) obtaining image data relating to an image;
(ii) modifying a first predetermined portion of the image data in substantially real time using an electronic processor in dependence upon at least one of a predetermined target wavelength range and a predetermined target intensity range, the at least one of determined in dependence upon a characteristic of the user's visual defect;
(iii) modifying the image data in substantially real time using the electronic processor by alternately applying the modified first predetermined portion to the first predetermined portion of the image data and a second predetermined portion of the image data at a predetermined rate; and
(iv) displaying the modified image data to the user using a display connected to the electronic processor.

2. The method according to claim 1 wherein,
at least one of:
the predetermined rate is at least one of randomized, fixed, and variable and determined in dependence upon, at least one of the user and the context of the user; and
the image data relates to at least one of a scene being viewed by a user captured with a camera, a scene captured with a camera, an image to be presented to a user captured with a camera, and content to be presented to a user.

3. The method according to claim 1 wherein,
the at least one of the predetermined target wavelength range and the predetermined target intensity range are established based upon the neurological and cortical processing of the user.

4. The method according to claim 1 wherein,
modifying the first predetermined portion of the image using the electronic processor comprises applying at least one algorithm of a plurality of algorithms to the first predetermined portion of the image.

5. The method according to claim 4 wherein,
the at least one algorithm of the plurality of algorithms is established in dependence upon a visual dysfunction of the user.

6. A method according to claim 1 wherein,
when modifying the first predetermined portion of the image in substantially real time is in dependence of the predetermined target wavelength range the predetermined portion of the image is mapped from its current spectral characteristics to the predetermined target wavelength range; and
when it is dependence of the predetermined target intensity range the predetermined portion of the image is mapped from its current intensity range to the predetermined target intensity range.

7. The method according to claim 1 wherein,
the predetermined portion of the image is at least one of an edge of an object within the image and a predetermined portion of an object within the image.

8. The method according to claim 1 further comprising;
repeating steps (ii) to (iv) using a different at least one of a predetermined target wavelength range and a predetermined target intensity range.

9. The method according to claim 1 wherein;
the electronic processor is at least one of within, within a separate electronic device directly connected to, and within a separate electronic device wirelessly connected to a head mounted unit comprising the camera and display.

10. The method according to claim 1 wherein;
the characteristic of the user's visual defect is downloaded to a memory associated with the electronic processor.

11. A device comprising:
an electronic processor for receiving image data relating to an image and executing an application to process the image for display to the user, the processing of the image comprising:
(i) modifying a first predetermined portion of the image data in substantially real time using an electronic processor in dependence upon at least one of a predetermined target wavelength range and a predetermined target intensity range, the at least one of determined in dependence upon a characteristic of the user's visual defect;
(ii) modifying the image data in substantially real time using the electronic processor by alternately applying the modified first predetermined portion to the first predetermined portion of the image data and a second predetermined portion of the image data at a predetermined rate; and
a display connected to the electronic processor for displaying the modified image data to the user.

12. The device according to claim 11 wherein,
at least one of:
the predetermined rate is at least one of randomized, fixed, and variable and determined in dependence upon, at least one of the user and the context of the user;
the at least one of the predetermined target wavelength range and the predetermined target intensity range are established based upon the neurological and cortical processing of the user; and
the image data relates to at least one of a scene being viewed by a user captured with a camera, a scene captured with a camera, an image to be presented to a user captured with a camera, and content to be presented to a user.

13. The device according to claim 11 wherein,
modifying the first predetermined portion of the image using the electronic processor comprises applying at least one algorithm of a plurality of algorithms to the first predetermined portion of the image; and
the at least one algorithm of the plurality of algorithms is established in dependence upon a visual dysfunction of the user.

14. A device according to claim 11 wherein,
when modifying the first predetermined portion of the image in substantially real time is in dependence of the predetermined target wavelength range the predetermined portion of the image is mapped from its current spectral characteristics to the predetermined target wavelength range; and
when it is dependence of the predetermined target intensity range the predetermined portion of the image is mapped from its current intensity range to the predetermined target intensity range.

15. The device according to claim 11 wherein,
the predetermined portion of the image is at least one of an edge of an object within the image and a predetermined portion of an object within the image.

16. The device according to claim 11 further comprising;
repeating steps (i) and (ii) using a different at least one of a predetermined target wavelength range and a predetermined target intensity range to generate a new image for display to the user.

17. The device according to claim 11 wherein;
the electronic processor is at least one of within, within a separate electronic device directly connected to, and within a separate electronic device wirelessly connected to a head mounted unit comprising the camera and display.

18. A non-transitory tangible computer readable medium encoding a computer program for execution by a microprocessor, the computer program comprising the steps of:
(i) receiving image data relating to an image;
(ii) modifying a first predetermined portion of the image data in substantially real time using an electronic processor in dependence upon at least one of a predetermined target wavelength range and a predetermined target intensity range, the at least one of determined in dependence upon a characteristic of the user's visual defect;
(iii) modifying the image data in substantially real time using the electronic processor by alternately applying the modified first predetermined portion to the first predetermined portion of the image and a second predetermined portion of the image at a predetermined rate; and
(iv) providing the modified image data to a display for presentation to a user.

19. The non-transitory tangible computer readable medium encoding a computer program for execution by a microprocessor according to claim 18, wherein,
when modifying the first predetermined portion of the image in substantially real time is in dependence of the predetermined target wavelength range the predetermined portion of the image is mapped from its current spectral characteristics to the predetermined target wavelength range; and
when it is dependence of the predetermined target intensity range the predetermined portion of the image is mapped from its current intensity range to the predetermined target intensity range.

20. A non-transitory tangible computer readable medium encoding a computer program for execution by a microprocessor, the computer program further comprising the steps of:
repeating steps (ii) to (iv) using a different at least one of a predetermined target wavelength range and a predetermined target intensity range.
